(19) United States
(12) Patent Application Publication
(10) Pub. No.: US 2019/0100152 A1
(43) Pub. Date: Apr. 4, 2019

(54) ENTERTAINMENT SYSTEM AND METHOD

(71) Applicant: Panasonic Avionics Corporation, Lake Forest, CA (US)

(72) Inventor: Shankar Shastry, Irvine, CA (US)

(73) Assignee: Panasonic Avionics Corporation, Lake Forest, CA (US)

(21) Appl. No.: 15/722,288

(22) Filed: Oct. 2, 2017

(51) Int. Cl. B60R 11/02; B60N 2/48; G06F 3/147; H04N 5/44

(52) U.S. Cl. CPC B60R 11/0229; B60N 2/4876; B60R 2011/0017; H04N 5/4401; G06F 3/147

(57) ABSTRACT

A system for providing entertainment on a vehicle for passengers in which the system includes a network and a content data source onboard the vehicle. The content data source stores media files and is connected in communication with the network. Seat displays disposed in the vehicle are connected in communication with the network and configured to present media selections to passengers corresponding to media files available from the content data source. Each seat display is configured to receive an input from a passenger for playing a selection and includes a data processor executing program logic. The program logic performs tasks including accepting authentication information from a passenger, verifying the authentication information received by comparison with information available from the network, and if the authentication information is verified, presenting a media selection corresponding to a media file associated with the authentication information.

### CROSS-REFERENCE TO RELATED APPLICATIONS

Not Applicable

### STATEMENT RE: FEDERALLY SPONSORED RESEARCH

Not Applicable.

### COPYRIGHT NOTICE

A portion of the disclosure includes material subject to copyright protection. The copyright owner has no objection to the facsimile reproduction by anyone of the patent disclosure as it appears in the Patent and Trademark Office patent file or records, but otherwise reserves all copyright rights whatsoever.

### TECHNICAL FIELD

The present disclosure relates generally to vehicle entertainment systems, and more particularly to entertainment systems on vehicles intended for commercial mass transport of passengers.

### BACKGROUND

Vehicles used for commercial transport of passengers often include an entertainment system for relieving passenger boredom. Entertainment systems for longer trips generally provide more features as the potential for passenger boredom increases with trip duration. A frequently included feature of such entertainment systems is audio and video on demand (AVOD). AVOD provides audio and video selections for a passenger to choose from and consume during a trip. Vehicles with AVOD-capable entertainment systems often include a display device installed at each seat for a passenger to consume AVOD selections. Some entertainment systems also enable streaming of a selection to a passenger's personal electronic device (PED), such as a mobile phone, tablet computer, phablet (larger sized mobile phone bordering on tablet size), or laptop computer.

While entertainment systems including AVOD are satisfactory for most uses, there are disadvantages. One of the disadvantages is that AVOD selections are limited to what the vehicle carrier has made available. In particular, a passenger may not find anything of interest among the selections. Passengers traveling with young children may prefer content that is not available from the AVOD system. While it is possible for passengers to bring their own content aboard via PED, passengers may wish to avoid supplying a PED for younger children and/or may be travelling with several young children and not have a PED available for each child.

Hence, improvements are desired for vehicle entertainment systems.

### SUMMARY OF THE DISCLOSURE

In one aspect, the disclosure describes a system for use with a passenger information processing device for providing entertainment on a vehicle for passengers. The system includes a network and a content data source onboard the vehicle with the content data source connected in communication with the network and including stored media files. The system additionally includes seat displays disposed the in the vehicle with each seat display connected in communication with the network. Each seat display is configured to present media selections to passengers corresponding to media files stored in the content data source and available over the network for streaming to the seat display in which each seat display is configured to receive an input from a passenger for streaming a selected media file to the seat display.

The system also includes a web interface available via an Internet connection with an information processing device, and a ground server not carried with the vehicle. The ground server is connected in communication with the web interface. A passenger uses the web interface prior to an upcoming trip by the vehicle to select a personal media file from a passenger information processing device in which a copy of the selected personal media file is communicated to the ground server and to the content data source aboard the vehicle, wherein the personal media file is available over the network from the content data source upon entry of authentication information by the passenger. In a further aspect, the web interface requires entry of information identifying at least one future trip scheduled by the vehicle, which after completion of the trip, any copy of the personal media file is deleted from the content data source.

In another further aspect, each seat display includes program logic which performs task including accepting authentication information from a passenger; verifying the authentication information received by comparison with information available from the network, and if the authentication information is successfully verified, presenting a media selection corresponding to the personal media file that was selected for upload. In yet another further aspect, the authentication information includes a password and username entered by the passenger that selected the personal media file for upload.

In a still another further aspect, the system includes an onboard server connected in communication with the network and carried with the vehicle. The onboard server includes data storage in which the content data source forms at least a portion of the data storage of the onboard server. In yet another further aspect, available storage space of the content data source is monitored, and if insufficient space is available for storage of a personal media file, and if a personal media file from a completed trip is stored, the personal media file from a completed trip is deleted from the content data source.

In a different aspect, the disclosure describes a method for providing entertainment on a vehicle for passengers. The method includes providing a network and a content data source onboard the vehicle and connecting the content data source in communication with the network, receiving a copy of at least one media file from a passenger prior to a trip by the vehicle and storing a corresponding copy of the at least one media file in the content data source. The method additionally includes accepting authentication information from a passenger aboard the vehicle via an information processing device, and verifying the authentication information received by comparison with information available from the network. If the authentication information is verified, the method includes permitting access to the corresponding copy of the at least one media file via the information processing device.

In a further aspect, the method includes disposing seat displays in the vehicle and connecting each seat display in communication with the network, in which accepting authentication information from the passenger includes accepting the authentication information from the passenger via a seat display. In another further aspect, permitting access to the corresponding copy of at least one media file via the information processing device includes presenting a media selection to the passenger which results in streaming of the corresponding copy to the information processing device for viewing thereon by the passenger.

In yet another further aspect, the method includes providing a web interface available via an Internet connection, wherein receiving a copy of at least one media file includes the passenger selecting at least one media file through the web interface of which a copy of the media file is uploaded to a server. In still another further aspect, receiving a copy of at least one media file from a passenger prior to a trip by the vehicle and storing a corresponding copy of the at least one media file in the content data source, includes copying a corresponding file to a portable media loader and copying a corresponding file from the portable media loader to the content data source. In yet another further aspect, receiving a copy of at least one media file from a passenger prior to a trip by the vehicle and storing a corresponding copy of the at least one media file in the content data source, includes the passenger identifying at least one of a departure and a return trip, in which the method further includes deleting the corresponding copy of the at least one media file from the content data source after completion of at least one of the departure and return trip.

In still another further aspect, receiving at least one media file from a passenger prior to a trip by the vehicle and storing a corresponding copy of the at least one media file in the content data source, includes receiving a password and username from the passenger and associating the at least one media file with the username. In addition, verifying the authentication information received includes determining whether a username and password entered by a passenger when onboard correspond to one another.

In a different aspect, the disclosure describes a system for providing entertainment on a vehicle for passengers. The system includes a network and a content data source onboard the vehicle, the content data source storing media files with the content data source connected in communication with the network. The system additionally includes seat displays disposed in the vehicle. Each seat display is connected in communication with the network and configured to present media selections to passengers corresponding to media files available from the content data source on the network in which each seat display is configured to receive an input from a passenger for playing a selection. Each seat display includes a data processor executing program logic.

The program logic performs tasks including accepting authentication information from a passenger, verifying the authentication information received by comparison with information available from the network, and if the authentication information is verified, presenting a media selection corresponding to a media file associated with the authentication information. In a further aspect, the system includes an onboard server connected in communication with the network and carried with the vehicle, the onboard server including data storage in which a portion of the data storage comprises the content data source. In another further aspect, the media file associated with the authentication information is composed of a copy of a media file provided by the passenger to the content data source prior to boarding the vehicle.

In another further aspect, the system is for use with a passenger information processing device, with the system including a web interface available via an Internet connection with a passenger information processing device prior to a scheduled trip by the vehicle, and a ground server not carried with the vehicle. The ground server is connected in communication with the web interface in which the web interface is used by the passenger to select a media file on the passenger information processing device prior to the scheduled trip to upload a copy of the selected media file and communicate a copy of the selected media file from the passenger information processing device to the ground server and from the ground server to the onboard server with the copy of the selected media file associated with authentication information corresponding to that of the passenger.

In a further aspect, the system includes a portable media loader in which the selected media file is communicated from the ground server to the portable media loader via a portable media loader and from the portable media loader to the onboard server. In another further aspect, the authentication information includes a password and username entered by the passenger via the web interface prior to vehicle boarding in which verifying the authentication information includes determining whether the password and username entered by the passenger when onboard correspond to one another. In a still further aspect, the media file associated with the authentication information is available only for at least one of a departing and return trip identified by the passenger prior to boarding the vehicle.

Other aspects and advantages will become apparent from the following description, taken in conjunction with the accompanying drawings.

### BRIEF DESCRIPTION OF THE DRAWINGS

The various features of the present disclosure will now be described with reference to the drawings of the various aspects disclosed herein. In the drawings, the same components may have the same reference numerals. Note that the drawings are not intended to be to scale or show actual quantities of components or relative sizes. The illustrated aspects are intended to illustrate, but not to limit the present disclosure. The drawings include the following figures briefly described as follows:

FIG. 1 schematically illustrates a system a system for providing entertainment on a vehicle for the passengers of the vehicle;

FIG. 2 schematically illustrates an onboard server and a seat display from FIG. 1;

FIG. 3 schematically illustrates logic executed by a data processor of a seat display in a flow chart;

FIG. 4 illustrates an example of a login screen that could be used to receive authentication information from a passenger;

FIG. 5 illustrates an example screen display that the logic of FIG. 3 may show to present media selections to a passenger on a seat display;

FIG. 6 illustrates an example web interface that may be displayed via an Internet connection with a passenger information processing device;

FIG. 7 schematically illustrates logic in a flow chart that may be employed by a server in displaying the web interface of FIG. 6 on a passenger information processing device;

FIG. 8 schematically illustrates logic that may be employed by an onboard server of the vehicle.

FIG. 9 schematically illustrates an alternative second web page for the example web interface of FIG. 7; and

FIG. 10 schematically illustrates logic in a flow chart that may be employed by a server in displaying the web interface of FIG. 6 on a passenger information processing device when using the alternative second web page of FIG. 9.

### DETAILED DESCRIPTION

As a preliminary note, the terms “component”, “module”, “system,” and the like as used herein are intended to refer to a computer-related and/or information processing entity, either software-executing general or special purpose processor, hardware, firmware and/or a combination thereof. For example, a component may be, but is not limited to being, a process running on a hardware processor, a hardware processor, an object, an executable, a thread of execution, a program, and/or a computer. For example, a controller or control system may be implemented in software, hardware, and/or a combination thereof, and may include a group of two or more control systems working cooperatively.

By way of illustration, both an application running on a server and the server can be a component. One or more components may reside within a process and/or thread of execution, and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), solid state memory device or any other storage device, in accordance with the claimed subject matter.

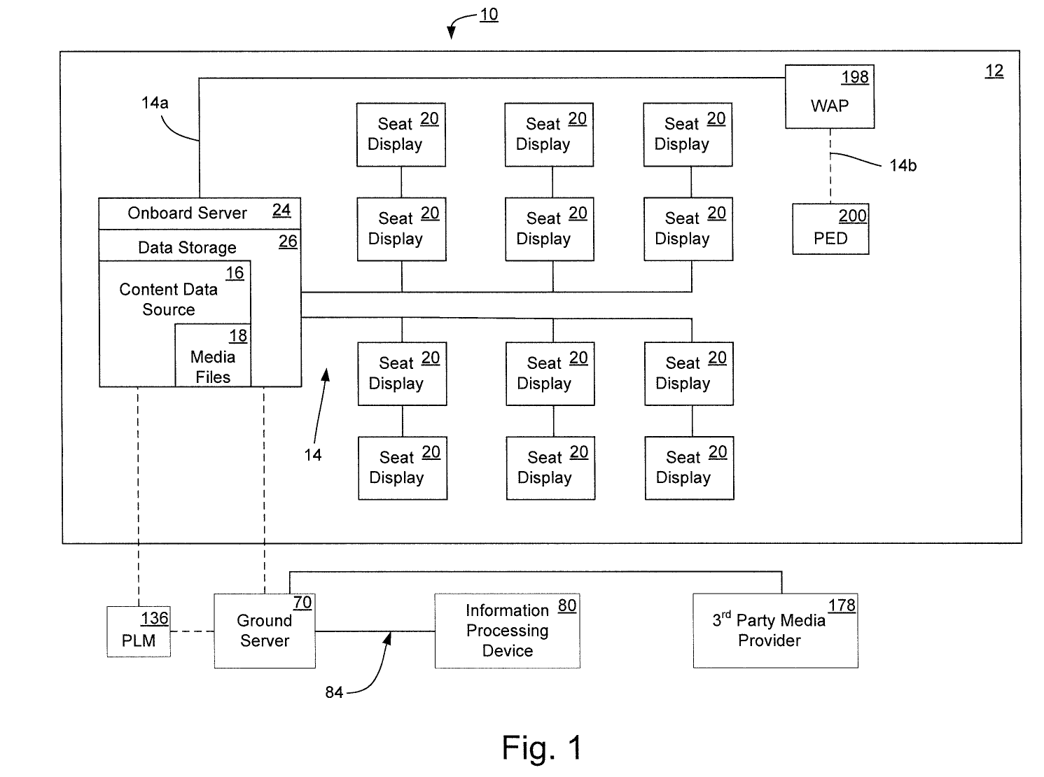

In one aspect, the following disclosure describes a system, indicated generally in FIG. 1 by reference numeral 10. More particularly, FIG. 1 schematically illustrates the system 10, which is for providing entertainment on a vehicle 12 for the passengers of the vehicle. FIG. 1 illustrates the system 10 applied to an aircraft as an illustrative, non-limiting example. However, the vehicle 12 is not limited to any particular vehicle type, and may be applied to other types of vehicles for transporting passengers, such as trains, ships, ferries, or busses. When provided for an aircraft, such a system 10 is commonly referred to an IFE (inflight entertainment) system or an IFEC (inflight entertainment and connectivity) system.

The system 10 includes a network 14 and a content data source 16 onboard the vehicle 12. The content data source 16 stores media files 18 with the content data source connected in communication with the network 14. The system further includes seat displays 20 disposed in the vehicle 12 for viewing by passengers. Each seat display 20 is connected in communication with the network 14 and configured to present media selections to passengers corresponding to media files 18 available from the content data source 16 on the network.

A seat display 20 is mounted at each seat in the vehicle 12 for viewing and use by a passenger at that seat. Generally, a seat display 20 is mounted to the back of each seat in the vehicle 12 for viewing and use by a passenger or user in the seat immediately behind the seat to which the seat display is mounted with the seats arranged in rows. For a seat for which there is no seat forward thereof, the seat display 20 is mounted to a bulk head in front of the seat or other structure. Alternatively, such a seat display 20 mounts to a seat arm and is retractable into the seat arm when not in use. The seat displays 20 allow a passenger to select from multiple video and/or audio selections corresponding to the media files 18 in the content data source 16 and available for streaming over the network 14 to a seat display.

The seat displays 20 may also provide access to games, communication applications (e.g., telephone service, messaging, etc.), Internet browsing, and other computer applications. Each seat display 20 includes an operating system (OS), which may be an OS distributed under the trademark ANROID by Google Inc., or a modified version thereof. The OS may be of other types as well, such as an OS distributed under the trademark IOS by Apple Inc. (10S is a trademark of Cisco Technology, Inc., licensed by Apple Inc.). Alternatively, the OS may be of the type distributed by Microsoft Corporation under the trademark WINDOWS, and the OS may be of other types, such as that distributed under the trademark LINUX.

Seat displays 20 as described herein are frequently referred to as smart monitors due to the ability to provide computer applications, process and store data internally, and present a user interface for interaction with users. The hardware for the seat displays 20 is preferably of conventional design for use on vehicles for public transport for passengers. For example, seat displays sold under the trademark ECO from Panasonic Avionics Corporation of Lake Forest, Calif., are suitable for use, as well as seat displays distributed under other trademarks by Panasonic Avionics Corporation. Seat displays of other types and from other manufacturers may be also be used. Sometimes seat displays 20 are referred to as seat video display units and/or video monitors.

In another aspect, the system 10 includes an onboard server 24 connected in communication with the network 14 and carried with the vehicle 12. The onboard server 24 includes data storage 26 in which a portion of the data storage comprises the content data source 16. The onboard server 24 is of conventional hardware design and commercially available, for example, from Panasonic Avionics Corporation of Lake Forest, Calif. Servers from other manufactures may be used as well. In the art, an onboard server 24 of a vehicle is sometimes referred to as a head-end server. FIG. 1 schematically illustrates a configuration having a single onboard server 24, but other configurations may have multiple onboard servers 24, depending on factors that include the size of the vehicle 12, the number of seat displays 20, and/or the desire for redundancy in case of failure or malfunction of an onboard server.

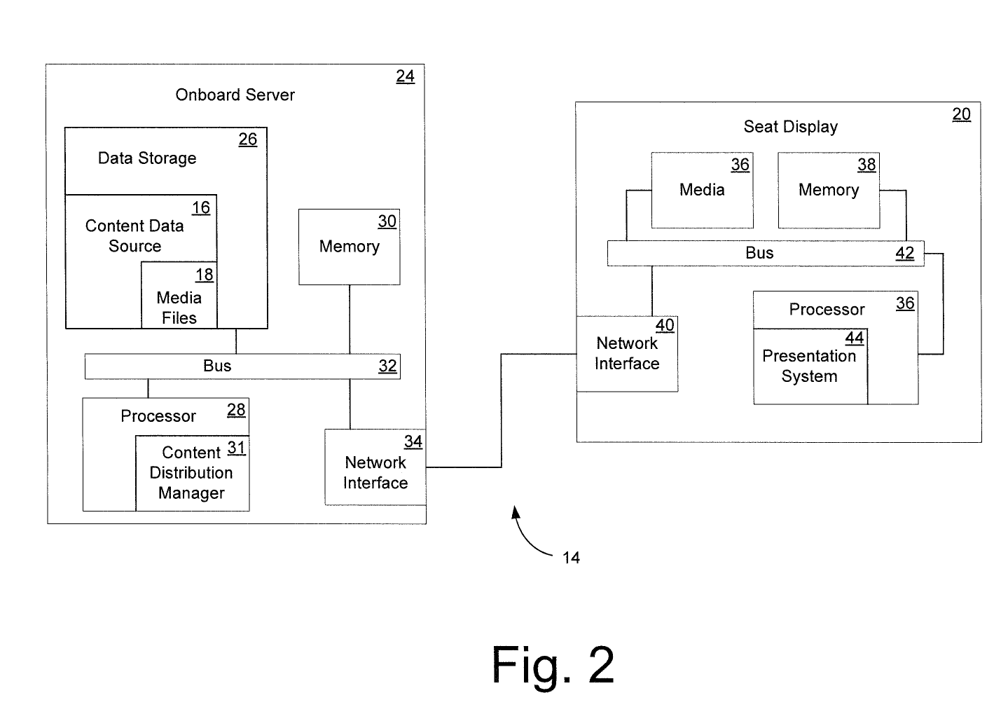

FIG. 2 schematically illustrates an onboard server 24 and a seat display 20 from FIG. 1 for clarity in describing additional details thereof. The data storage 26 of the onboard server 24 includes at least one solid-state drive (SSD) and one or more high performance processors 28 to enable the onboard server to stream media files 18 with high definition audio and video to the seat displays 20 simultaneously with acceptable viewing performance, i.e., without excessive buffering or stuttering. Generally, this requires a bit rate of about 5 Mbps for a 720p audio and video stream having 12 language selections. Panasonic Avionics Corporation has servers available that support from 300 Mbps to 1600 Mbps, depending on the class of server. A 1600 Mbps server can support up to 320 streams at 5 Mbps per stream. Many seat displays 20 support up to 1080p, which typically requires more than 5 Mbps per stream, and more recently, seat displays 20 have been introduced supporting 4K and 8K video. The required performance capability of the onboard server 24 increases with the number of seat displays 20 in the vehicle 12, with wide body aircraft typically having hundreds of seat displays 20 and demanding higher performance requirements.

Another advantage of an SSD is that it permits the media files 18 to be rapidly loaded or copied to the onboard server 24 to minimize vehicle 12 down time. Commonly, an onboard server 24 used on an aircraft for commercial passenger transport will store from between 300 gigabytes to 400 gigabytes of media files, with the average being around 350 gigabytes, for streaming to seat displays 20. The media files 18 are replaced periodically on the onboard server 24, usually monthly or weekly, as newer content becomes available. Each onboard server 24 is normally capable of storing between one and two terabytes of date in total, and usually around 1.6 terabytes.

The onboard server includes a memory 30 (RAM) and network interface 34, in which the memory, network interface, data storage 26, and processor 28 are connected in communication via at least one bus 32. The processor 28 executes software or program logic loaded from data storage 26 into the memory 30, such as an OS (preferably LINUX, but may be other types of OS). The software or program logic includes software or program logic 31 for managing the distribution of content from the content data source 16 in response to requests received via the network 14.

The network 14 connects the seat displays 20 and onboard server 24 in communication with another. The network 14 is preferably a conventional local area network (LAN) using Ethernet for communication between the seat displays 20 and onboard server 24. Preferably, the network 14 includes a throughput of at least gigabyte Ethernet using conventional 1000BASE-T or Copper-Gigabit wiring/cabling. Seat boxes (not shown) supply network connections and power to the seat displays 20. Seat boxes in the inflight entertainment field are sometimes called Power-Network Boxes (PNBs) as the seat boxes provide both power and network connections. Alternatively, seat boxes may be referred to as Seat Interface Boxes (SIBs). If larger seat displays are used, such as seat displays 20 sold under the trademarks of ELITE SERIES V2 and ALTUS by Panasonic Avionics Corporation, the seat boxes may provide network connections only, with power provided separately via seat electrical boxes (SEBs) or seat power modules (SPMs). Power Network Boxes, Seat Interface Boxes, Seat Electrical Boxes and Seat Power Modules are all available from Panasonic Avionics Corporation. The term seat box as used herein includes types that provide both power and network connections for the seat displays 20 and switches that provide only network connections.

Each seat display 20 includes media 28 for non-volatile memory storage, such as a memory card according to the Secure Digital standard, i.e., an SD flash memory card, or other standard. Smart monitors currently available from Panasonic Avionics Corporation under the trademark ECO have SD cards according to the eXtended-Capacity standard, i.e., SDXC flash memory cards. The total memory capacity is usually 64 GB, but may vary according to the class of seating in the vehicle 12, with seat displays for premium class seating frequently being provided with greater capacity memory cards. It is anticipated that as memory prices decrease and/or technology improves, higher capacity cards will be provided and/or other types of non-volatile memory such as an SSD or other types of memory. System files in the seat displays 20 normally require around 14 GB of storage, i.e., applications, a graphical user interface (GUI), metadata, operating system, etc. The remaining portion of the non-volatile memory may be used for storage of media files locally on a seat display 20.

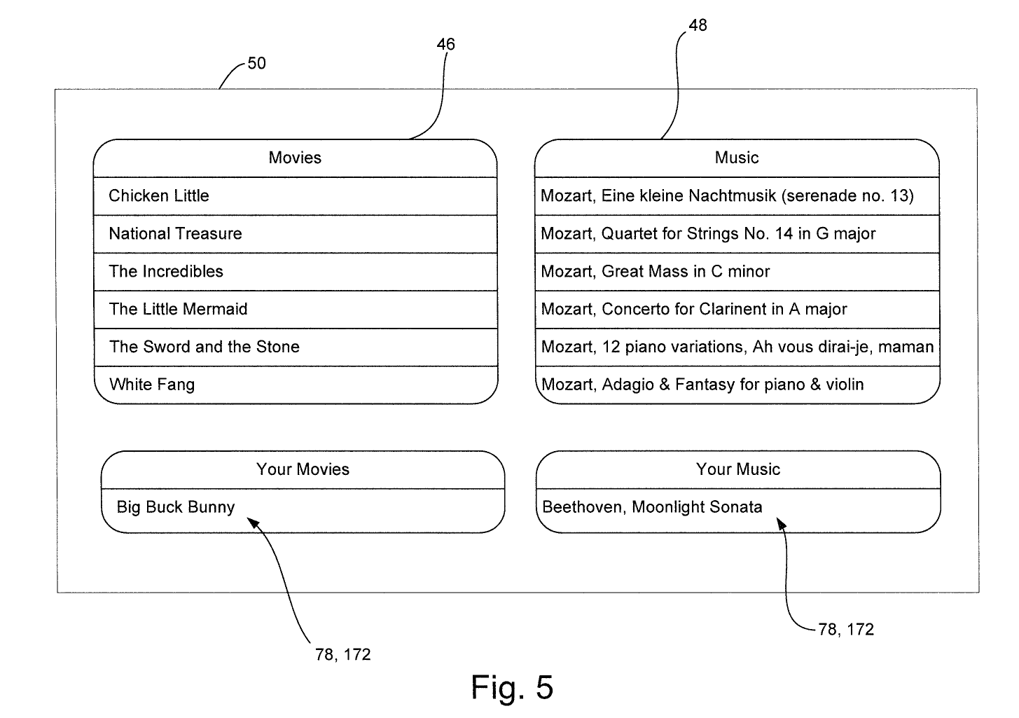

Each seat display 20 includes a processor 36, memory 38, and network interface 40 connected in communication via at least one bus 42. The processor 36 executes software or program logic loaded from the media 36, such as an OS. As previously described, the OS may be ANDROID or a modified version thereof or other type of OS. Software or program logic 44 is including for presenting media selections corresponding to media files 18 in the content data source 16. By way of illustrative, non-limiting example, FIG. 5 illustrates a screen display 50 the program logic 44 may show to present media selections 46 and 48 to a passenger on a seat display 20. Some of the media selections 46 corresponding to video content, and other media selections 48 correspond to audio content. As will be appreciated by those skilled in the art, many other formats may be used for the screen display 50 to present media selections.

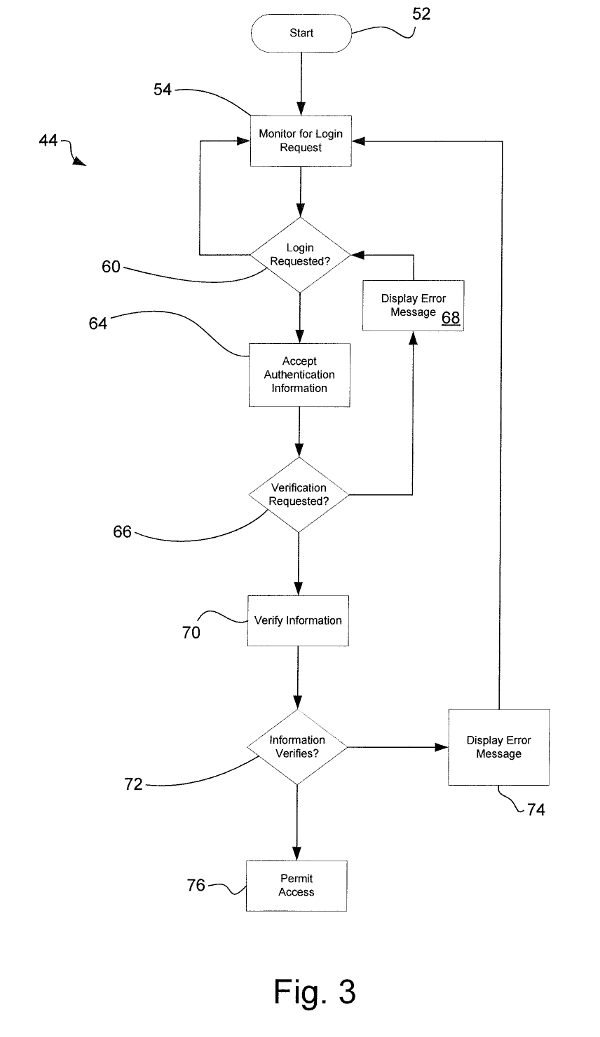

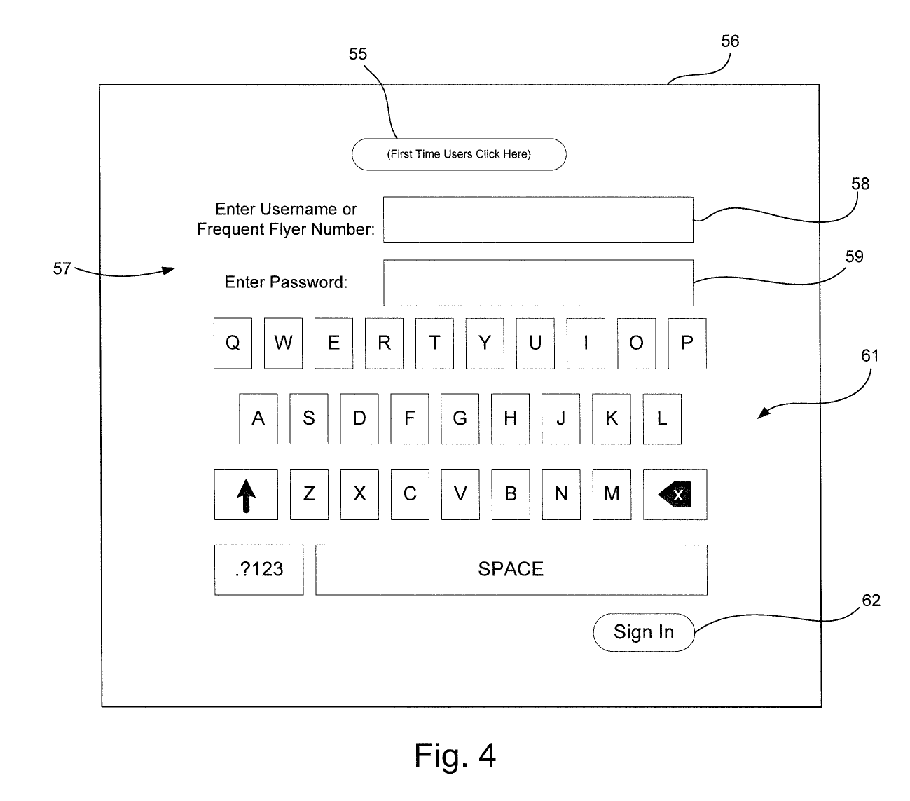

The presentation system logic 44 executed by the processor 36 performs tasks including accepting authentication information from a passenger and verifying the authentication information received by comparison with information available from the network 14. If the authentication information is verified, the presentation system logic 44 presents a media selection corresponding to a media file associated with the authentication information. FIG. 3 schematically illustrates the presentation system logic 44 in a flow chart. After the presentation system logic is booted in start block 52, the presentation system logic 44 monitors for a login request in block 54. A passenger may start a login request from a pull down menu to cause the presentation system logic 44 of a seat display 20 to show a login screen 56 as in FIG. 4.

FIG. 4 is an illustrative, non-limiting example of a login screen 56 that could be used to receive authentication information 57 from a passenger. As will be appreciated by those skilled in the art, many other formats could be used for the login screen 56. The authentication information 57 includes a username 58, which could be a loyalty identification, such as a frequent flyer number, an email address, mobile telephone number, or other identification. In addition, the authentication information includes a password 59. The password 59 may be according to standards currently recommended in the computing industry for security, e.g., a minimum password length that makes it difficult to brute force, and includes numerals, both upper and lower case characters, and one or more special characters. If the passenger does not have an account or is a first user, an optional button 55 may be provided to take the passenger to a page for creating a username and password and entering other pertinent information.

If the seat display 20 includes a touch screen, an on-screen keyboard 61 may be provided for entering the information. Alternatively, the authentication information 57 may be entered using an off-screen keyboard, such a control unit or physical keyboard. If the seat display 20 includes a microphone or permits headset to be connected that includes a microphone, voice recognition may be employed to permit the authentication information to be spoken. If the seat display is suitably equipped, the password may be in the form of biometric information, such as a fingerprint reader and/or sensor for face recognition or iris scanning.

Returning to FIG. 3, the logic 44 determines in decision block 60 whether login is requested, e.g., whether the sign in key 62 has been activated. If not, the logic 44 waits and when the sign in key is activated, accepts the entered authentication information in block 64. The logic 44 determines in decision block 66 whether verification should be requested based on preliminary checking, e.g., both username and password entered, password is of the minimum length, etc. If not, an error or help message is display in block 68, and the logic 44 returns to waiting for a login request in block 60. If preliminary checking is passed, the logic 44 proceeds with verifying the authentication information in block 70 by comparison with information available from the network 14. By way of illustrative, non-limiting example the authentication information may be encrypted and communicated over the network 14 to the onboard server 24, which queries records in data storage 26 to determine if the hash from the entered password corresponds to the entered username. If so, the authentication information verifies, and if not, the authentication does not verify, and in either case the onboard server 24 communicates the verification result to the seat display logic 44.

Alternatively, the onboard server 24 may communicate the authentication information in encrypted format to a ground server 70 (see FIG. 1). The communication is preferably by wireless means, such as WiFi if the onboard server is in range of a WiFi signal source. Alternatively, the communication link may be via a ground tower or satellite for communicating the information to the ground server 70. In these alternatives, the ground server 70 queries records to determine if the password and username in the authentication information correspond, and if so, communicates a positive verification result to the onboard server 24, and if not, communicates a negative verification result to the onboard server 24. The onboard server in turn communicates the verification result to the seat display logic 44 over the network 14.

The seat display presentation logic 44 determines if the information available from the network 14 for the authentication information 57 is negative or positive in decision block 72. If the verification result is negative, an error message is displayed in block 74 and the logic flow returns to monitor for another login request in block 54 (the error message may request re-entry of the information or inquire if the passenger has forgotten their password and/or username). If the verification result is positive, the logic 44 proceeds to block 76 and presents a media file 78 associated with the authentication information 57, such as that shown in FIG. 5. One or more media files 78 associated with the authentication information 57 may be presented, and the media files may be of different types, such a video, audio, pdf, or other type of media file.

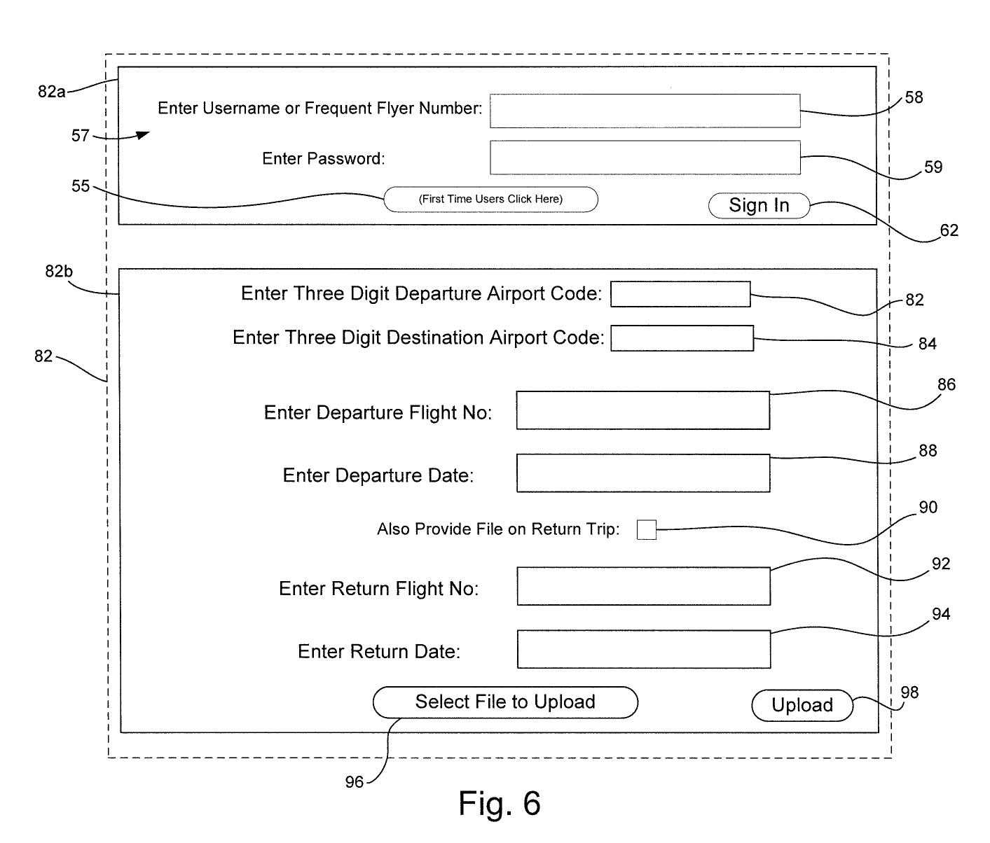

Returning to FIG. 1, the system 10 is for use with a passenger information processing device 80, such as a desktop computer, laptop, tablet, or other information processing device having at least one media file 78 stored thereon. The system 10 includes a web interface 82, shown by way of illustrative, non-limiting example in FIG. 6, available via an Internet connection 84 with the passenger information processing device 80 prior to a scheduled trip by the vehicle 12.

The system 10 further includes a ground sever 70 not carried with the vehicle 12, with the ground server 10 connected in communication with the web interface 82. The communication may be direct or indirect. For example, the web interface 82 may be hosted by another server, connected in communication with the ground server 70. The web interface 82 is accessed or used by a passenger to select a media file on the passenger's information processing device 80 prior to a scheduled trip to upload a copy of the selected media file and communicate a copy of the selected media file from the passenger information processing device 80 to the ground server 70. From the ground server 70, a copy of the selected media file is communicated to the onboard server 24 with the copy of the selected media filed associated with authentication information corresponding to that of the passenger. That is, the copy of the selected media file is associated with the passenger's username 58. The selected media file is alternatively referred to herein as a personal media file 78 (see FIG. 5).

With reference to FIG. 6, the web interface 82 includes two pages. The first or landing page 82a, requests a username 58 and password 59, i.e., authentication information 57. In case of a passenger that does not have authentication information, a button 55 may be provided to take the passenger to a page to create a username 58 and password 59, and enter other information. An onboard keyboard 61 may be provided as well as previously described in connection with FIG. 4, but in the interests of brevity is omitted in FIG. 6. After the passenger enters the authentication information 57, the sign in button or key 62 is activated for verification of the authentication information.

If the authentication information 57 is correct, the web interface 82 displays the next page 82b. The page 82b of the web interface 82 requests information from the passenger regarding the upcoming trip, such as the three digit airport code for the departure airport in field 84. For example, LAX is the three digit airport code for Los Angeles International Airport. The web interface 82 requests the three digit airport code for the destination airport in field 84. For example, SEA is the three digit airport code for the Seattle-Tacoma International Airport. The departure flight number and date is respectively requested in the following two entry fields 86 and 88.

A check box 90 is provided to inquire whether the media file should also be provided on the return trip. If the box 90, the next two fields 92 and 94 request the return flight number 92 and return date. The penultimate field 96 is a button that when activated permits the user to browse the files on the passenger information processing device 80 and select a media file. The final field 98 is an upload button, which uploads or communicates a copy of the selected media file to the ground server 70. As will be appreciated by those skilled in the art, the information could be requested in other ways, such as requesting a confirmation code from the passenger or communicating with a database having a record of upcoming trips for the passenger after the passenger has supplied valid authentication information.

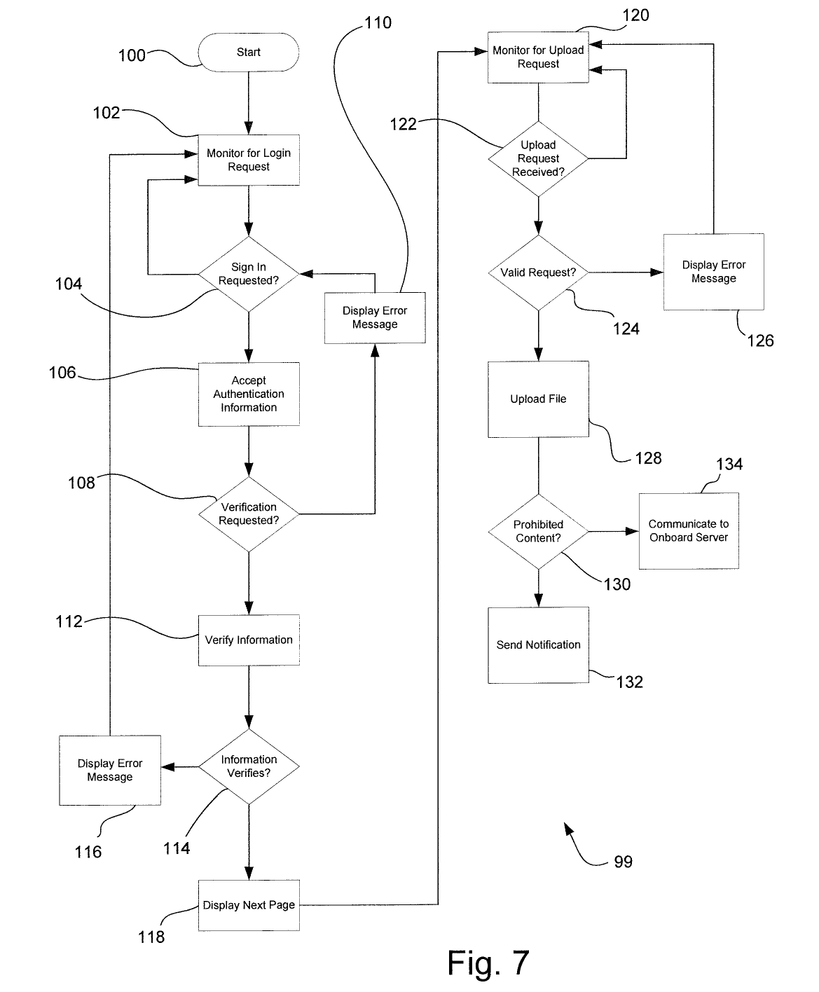

FIG. 7 schematically illustrates the logic 99 employed by a server, such as the ground server 70 and in particular, one or more processors thereof, for the web interface 82. After the logic 99 is booted or started in block 100, the logic waits or monitors for a login request in block 102. A passenger may begin a login request by entering the domain or Internet address for server hosting the web interface 92, for example, the ground server 70. In response, the logic 99 causes the server to serve the landing page 82a of the web interface 82 to the passenger's information processing device 80. Thereafter, in decision block 104, the logic 99 determines whether sign in has been requested, i.e., whether the sign in field/button 62 in FIG. 6 has been activated. If not, the logic 99 continues to monitor for a login request.

If the logic 99 determines sign in has been requested in decision block 104, the logic proceeds to process block 106 and accepts the entered authentication information 57, i.e., username 58 and password 59, in process block 106. In decision block 108, the logic determines where verification should be requested based on preliminary checking, such as the minimum length for the password, whether the username has disallowed special characters or spaces, etc. If the determination in decision block 108 is that verification should not be requested, after display of an error message in process block 110, the logic 99 returns to decision block 104 to wait for another sign in request. The error message may request re-entry of authentication information or supply a link to another webpage for recovery of authentication information should the passenger have forgotten their password and/or username.

If the determination in decision block 108 is that verification should be requested, the logic 99 proceeds to process block 112 to verify the authentication information. Verification is typically performed by ensuring that a hash corresponding to the entered password corresponds to the entered username by accessing records in data storage, e.g., a database inquiry. If the records are not stored on the server hosting the web interface 82, the authentication information 57 is encrypted prior to communicating the information to the server storing the database, and for greater security is encrypted in either case. In decision block 114, a determination is made whether the verification result is positive. If the verification result is negative, i.e., the password, specifically the hash resulting therefrom, does not correspond to the username, the logic 99 displays an error message in process block 116, and returns to monitoring for a log in request in block 102. If the verification result is positive, the logic 99 advances to the next page 82b of the web interface 82 in block 118. Thereafter, the logic 99 monitors for an upload request in block 120.

In block 122, the logic 99 determines if an upload request has been received. If the determination is negative, the logic 99 returns to block 120 and continues to monitor for an upload request. If the determination is in the affirmative in block 122, the logic 99 determines in block 124 whether request is valid by performing an initial validity check, e.g., proper number of characters entered in the fields, file selected, file does not exceed a maximum allowed size, dates are in proper format, return date is after departure date, etc. If the determination is that the request is not valid, the logic 99 displays an error message in block 126, and returns to block 120 to monitor for an upload request. If the request is valid, the logic 99 proceeds to upload the selected media file in block 128.

Thereafter, the logic 99 determines in block 130 whether the selected file includes prohibited content, for example, malware, legally forbidden content, content that infringes intellectual property rights, and/or other content forbidden by the terms and conditions of the vehicle 12 carrier. If the determination in block 130 is that the file includes prohibited content, the file is deleted and a notification is sent to the passenger in block 132. Otherwise the file is communicated to the onboard server in block 134 in accordance with the information entered by the passenger via the web interface 82. If the determination in decision block 130 is that the file does not include prohibited content, a notification may also be sent to the passenger at that juncture as well that the file will be made available.

Transferring the file to the onboard server 134 may be performed by any conventional method known in the art. For example, the communication may be via WiFi if the onboard server 70 is in range of a WiFi signal source. Alternatively, the communication may be via cellular communication. In yet another example, the communication may be via satellite communication. In still another example, the communication may via a portable media loader 136 as illustrated in FIG. 1. Media files 18 on the onboard server 24 are replaced periodically, usually monthly or weekly, as newer content becomes available. An onboard server 134 is typically capable of storing between one and two terabytes of date in total, and usually around 1.6 terabytes.

Transfer of media files 18 via portable media loader 136 is generally performed by copying the media files from a ground source, such as a ground server 70, to the portable media loader having media files stored thereon in non-volatile memory, such as an SSD of the portable media loader. The media files 18 are copied to the onboard server 24 from the portable media loader 136 typically via a wired connection through a media load port on the onboard server 70, for example, a connection through a universal serial bus (USB), or as alternative, through a wired Ethernet connection to the network 14. A portable media loader 136 is also known in the art as an onboard media loader.

The media file (personal media file) 78 selected by the passenger may therefore be copied to the onboard server 24 during normally periodic replacement of other media files 18. However, the passenger must therefore provide the media file 78 sufficiently in advance of the scheduled trip such that the media file may be included with a periodic replacement of media files 18 via the portable media loader 136.

As previously described, the data processor 28 of the onboard sever 26 includes software or program logic 31 executed by the data processor 28 for managing the distribution of the media files 18. The logic 31 executed by the data processor 28 performs tasks that include deleting a media file 78 supplied by a passenger (a personal media file) from the content data source 16 after completion of a trip. The logic 31 further performs tasks including monitoring the storage available in the content data source 16, and if a personal media file 78 from a completed trip is stored, the personal media file from the completed trip is deleted from the content data source.

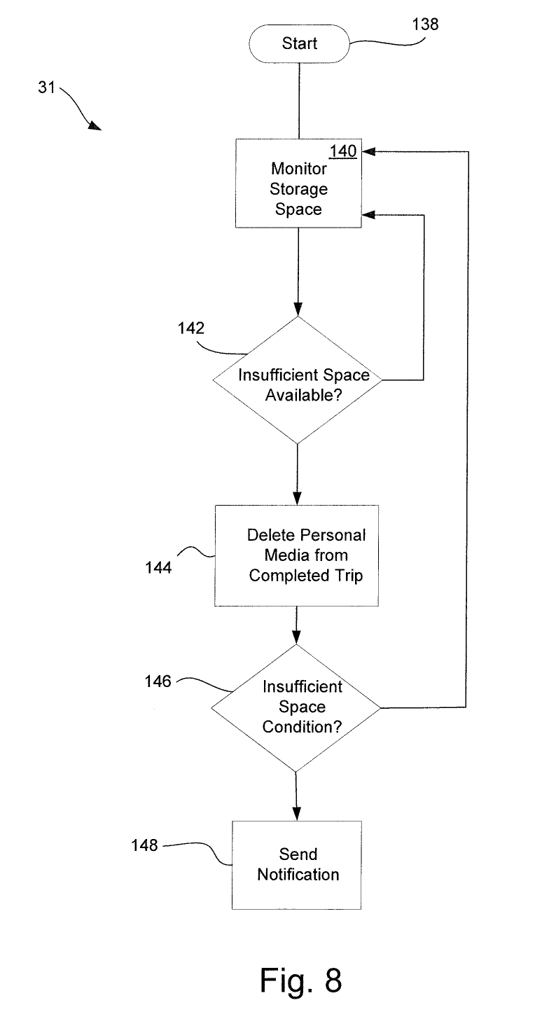

FIG. 8 illustrates a schematic diagram of the foregoing portion of the logic 31. After the logic 31 boots or launches in start block 138, the logic monitors the storage available of the content data source 16. In decision block 142, a determination is made whether there is insufficient space available for storage of a personal media file 78. For example, the onboard server 24 may receive a request from a ground server 70 to communicate a copy of a personal media file to the content data source 16 in which there insufficient space available in the content data source 16 to store the file personal media file. Insufficient space may arise for other reasons, such as storage of logs or information by the onboard server 24. If the determination in block 142 is that there is insufficient space available, personal media files 78 from completed trips are deleted from the content data source 16 in block 144. If the determination is that sufficient space is available, the logic 31 returns to block 140 and continues to monitor the storage space.

After deletion of a file or files in block 144, the logic 31 checks in block 146 to determine if there is still an insufficient storage space condition. If so, the logic 31 provides and/or sends a notification in block 148, which may be to a crew terminal in the vehicle 12, a personal electronic device carried by a crew member, and/or to a ground server 70 for communication to a network operation center. If the determination in block 146 is that there is sufficient storage space, the logic 31 returns to block 140 and continues to monitor the storage space available.

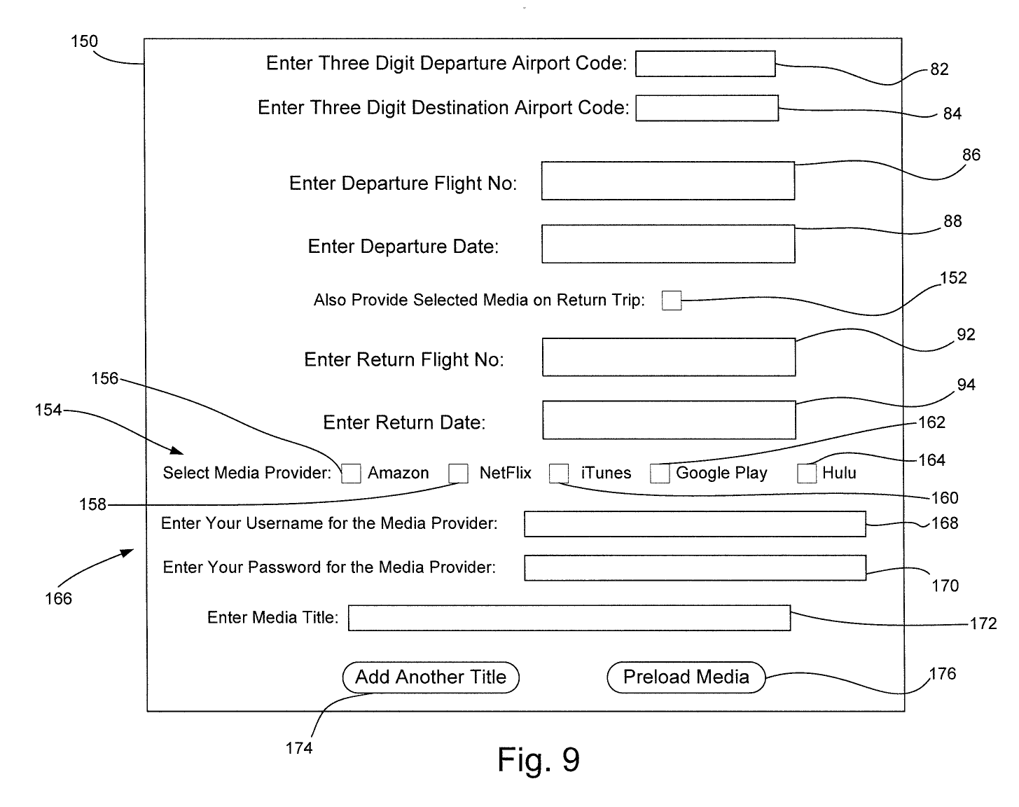

FIG. 9 schematically shows an alternative embodiment for use with 3^{rd} party media providers. In particular, FIG. 9 illustrates a webpage 150 for use instead of webpage 82b in the web interface 82 of FIG. 6. Using page 150, a passenger prior to a scheduled trip selects one or more media files for preloading on the onboard server 24 of the vehicle 12. Many of the entry fields are the same as in the previously described webpage 82b and are identified using identical reference numbers, such as the departure airport code 82, destination airport code 84, departure flight number 86, departure date 88, return flight number 92, and return date 94.

Rather than the passenger selecting a file for upload, webpage 150 is intended for a passenger to select media from a third party provider. Current media providers as of this date include media provided under the trademarks of AMAZON, NETFLIX, ITUNES, GOOGLE PLAY, and HULU by of way of non-limiting, illustrative, example. Further, the webpage 150 includes a check box 152 for whether the selected media should be provided for the return trip. If the box 152 is checked, the entry fields for the return flight number 92 and return date 94 become active and the passenger is required to supply that information.

The passenger is also requested to indicate or select the media provider 154. This may be provided via check boxes 156, 158, 160, 162, and 164 respectively for media providers supported by the vehicle carrier, in which one of the boxes must be checked on the web page 150. Alternatively, the media provider may be provided via a scroll menu. Further, account information 166 is requested for the media provider 154, namely, the passenger's username 168 and password 170 for that media provider.

Thereafter, the name or title 172 of the media is requested, which may be provided via a text entry box, a scroll menu, or a combination thereof, e.g., entering the first few letters of a word in the title, and thereafter scrolling through relevant search results. If the passenger desires to have more than one media title available, a button or selection 174 is provided for adding another title. After the passenger has entered a selection for a media title or titles, the passenger presses or activates a button field 176 to proceed with preloading the media on to the onboard server 24 for the vehicle 12.

Returning to FIG. 1, preloading the media involves a ground server 70 communicating with a server 178 of the media provider to obtain a copy of the selected media. FIG. 7 schematically illustrates the logic 179 employed by a server, such as the ground server 70 and in particular, one or more processors thereof executing the logic 179 for the web interface 82 and displaying the webpage 150. The logic 179 is identical to that previously described for FIG. 7 through the block 118 where the logic proceeds to display the next page 82b or 150 of the web interface 82 and the same reference numerals are used. Since that portion of the logic 179 is the same as previously described in connection with the logic 99 of FIG. 6, it is not repeated here.

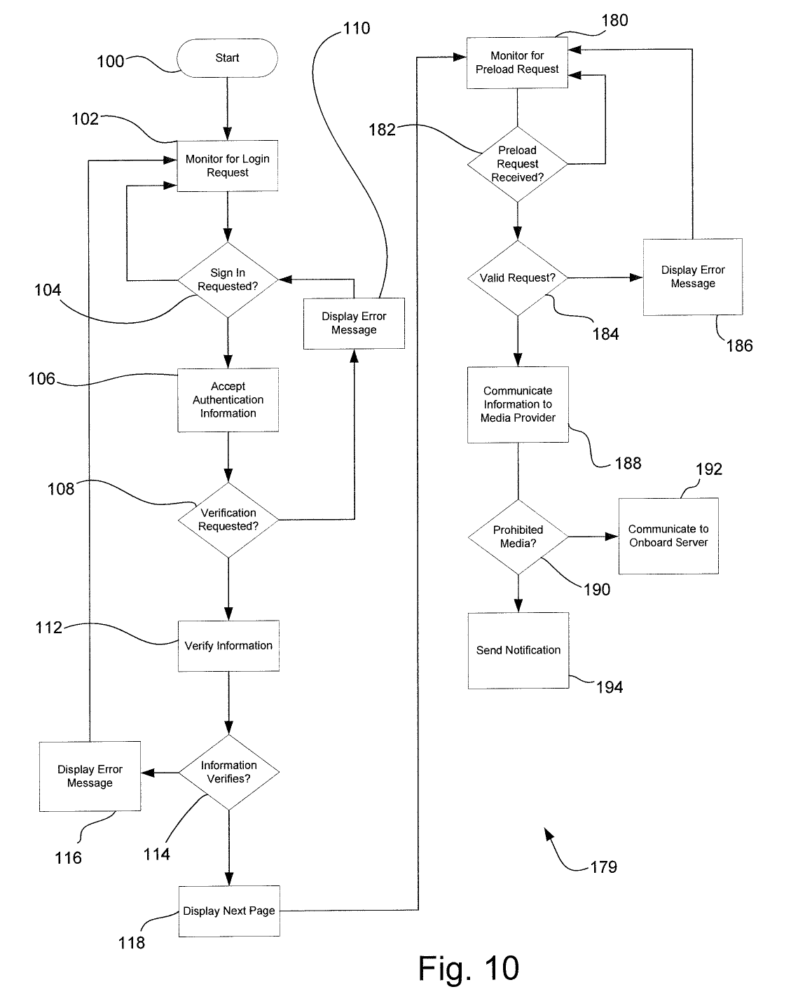

The logic 179 of FIG. 10 differs in that it displays a page 150 (see FIG. 9), and monitors for a preload request in block 180. In block 182 of FIG. 10, the logic 179 determines if a preload request has been received. If the determination is negative, the logic 179 returns to block 180 and continues to monitor for a preload request. If the determination is in the affirmative in block 182, the logic 179 determines in block 184 whether request is valid by performing an initial validity check, e.g., a valid media title or titles provided, username and password provided for the media provider, the media does not exceed a maximum allowed size in gigabytes, dates are in proper format, return date is after departure date, etc. If the determination is that the request is not valid, the logic 179 displays an error message in block 186, and returns to block 180 to monitor for a preload request.

If the request is valid, the logic 179 proceeds to communicate information to the media provider in block 188 and obtain a copy of the selected media 172. For security, the information is encrypted and may be communicated directly or directly, e.g., via an intermediate server. The information includes the passenger account information with the media provider 154, along with an identification of the selected media 172. The logic 179 determines in block 190 whether the media 172 is prohibited, e.g., does not include malware, is not of an inappropriate rating or subject matter for the geographic jurisdiction, does not exceed a maximum storage size in gigabytes, etc. If the media 172 is not prohibited a copy thereof is communicated to the onboard server 24 in block 192 (communication of the media 172 to the onboard server 24 is as previously described herein). Otherwise, the copy of the media 172 is deleted and a notification is sent to the passenger in block 194.

Due to regulations aircraft relying upon satellites for inflight connectivity generally cannot establish a satellite datalink to provide Internet connectivity to seat displays 20 until the vehicle 12 has reached an altitude of at least 10,000 feet (3,048 meters). Passengers on such an aircraft waiting for takeoff therefore cannot use the seat displays 20 to consume media from a media provider 154 via an Internet connection. The advantage of the system 10 described herein is that media selections 172 may be preloaded on to the onboard server 24 and consumed despite an absence of Internet connectivity. Since bandwidth is limited some airline carriers prohibit streaming of media from media providers 154 due to bandwidth limitations. In other situations, an airline carrier may allow such streaming, but limited bandwidth causes excessive stuttering or buffering wait times. The system 10 described herein nevertheless provides a way for passengers to select media from a media provider 154 for preloading and viewing on an upcoming trip that advantageously overcomes such limitations.

Returning to FIG. 1, the system 10 includes a network 14 having a wired segment 14a and a wireless segment 14b. The wired segment 14a connects the onboard server 24 and seat displays 20 in communication with one another. In addition, the wired segment 14a connects to one or more wireless access points (WAPs) 198 in the vehicle 12. The WAPs 198 enable a passenger with a PED 200 to enable streaming of a media file 18 from the content data source 16 to the passenger's PED. While a seat display 20 may have a larger display and provide a better viewing experience for uploaded or preloaded media files 18, the system 10 may also be used with passenger PEDs 200. In this situation, the onboard server 24 would host a login page, such as that illustrated in FIG. 4, on the network 14. A passenger using a PED 200 would access the page over the wireless network segment 14b via a WAP 198. After logging in, the passenger would be presented with a web page such as that shown in FIG. 5, also hosted by the onboard server 24, for streaming of media to a PED 200, including a personal media file 78 or a preloaded media file 172 from a media provider. The logic executed by onboard server 24 in serving the web page would be substantially the same as that illustrated in FIG. 3.

Various changes and modifications can be made as will be recognized by those of ordinary skill in the art. While the system 10 has been described in conjunction with a vehicle 12 including an onboard server 24, the system 10 could be provided on a vehicle 12 without an onboard server. In a configuration without an onboard server 24, content would be distributed on media 36 of the seat displays 20 by streaming from one seat display to another if a media file not available in local media storage of the requesting seat display 20. In some configurations, a file server in addition to an onboard server 24 may be provided on the vehicle 12. Authentication information 57 could rely upon biometric data, such as a fingerprint or retina scanner or a sensor for face recognition so that a passenger is not required to type in a password 59. In checking for valid information, the logic could initially check for a valid and existing username prior to proceeding to a determination of whether an entered password is valid and corresponds to the entered username. The web interface 82 could request metadata information for a file and/or other information, and/or an upload/storage fee. The vehicle carrier could maintain an account with a media provider such that passengers are not required to supply individual account information for selecting media from that media provider.

As changes can made, the foregoing disclosure and examples described herein are to be considered illustrative and not restrictive and the invention is not to be limited to the details given herein, but may be modified within the scope and equivalence of the appended claims.

1. A system for providing entertainment on a vehicle for passengers, the system comprising:
a network and a content data source onboard the vehicle, the content data source storing media files with the content data source connected in communication with the network;
seat displays disposed in the vehicle, each seat display connected in communication with the network and configured to present media selections to passengers corresponding to media files available from the content data source on the network in which each seat display is configured to receive an input from a passenger for playing a selection;
each seat display including a data processor executing program logic, the program logic performing tasks including:
accepting authentication information from a passenger;
verifying the authentication information received by comparison with information available from the network, and if the authentication information is verified, presenting a media selection corresponding to a media file associated with the authentication information.

2. The system of claim 1, further comprising an onboard server connected in communication with the network and carried with the vehicle, the onboard server including data storage in which a portion of the data storage comprises the content data source.

3. The system of claim 1, wherein the system is for use with a passenger information processing device, the system further comprising:
a web interface available via an Internet connection with a passenger information processing device prior to a scheduled trip by the vehicle;
a ground server not carried with the vehicle, the ground server being connected in communication with the web interface in which the web interface is used by the passenger to select a media file on the passenger information processing device prior to the scheduled trip to upload a copy of the selected media file and communicate a copy of the selected media file from the passenger information processing device to the ground server and from the ground server to the onboard server with the copy of the selected media file associated with authentication information corresponding to that of the passenger.

4. The system of claim 3, further comprising a portable media loader in which the selected media file is communicated from the ground server to the portable media loader via a portable media loader and from the portable media loader to the onboard server.

5. The system of claim 3, wherein the authentication information comprises a password and username entered by the passenger via the web interface prior to vehicle boarding in which verifying the authentication information includes determining whether the password and username entered by the passenger when onboard correspond to one another.

6. The system of claim 1, wherein said media file associated with the authentication information comprises a copy of a media file provided by the passenger to the content data source prior to boarding the vehicle.

7. The system of claim 5, wherein said media file associated with the authentication information is available only for at least one of a departing and return trip identified by the passenger prior to boarding the vehicle.

8. A method for providing entertainment on a vehicle for passengers, the method comprising:
providing a network and a content data source onboard the vehicle and connecting the content data source in communication with the network;
receiving a copy of at least one media file from a passenger prior to a trip by the vehicle and storing a corresponding copy of the at least one media file in the content data source;
accepting authentication information from a passenger aboard the vehicle via an information processing device;
verifying the authentication information received by comparison with information available from the network, and if the authentication information is verified, permitting access to the corresponding copy of the at least one media file via the information processing device.

9. The method of claim 8, further comprising disposing seat displays in the vehicle and connecting each seat display in communication with the network, wherein said accepting authentication information from the passenger includes accepting the authentication information from the passenger via a seat display.

10. The method of claim 8, further comprising providing a web interface available via an Internet connection, wherein said receiving a copy of at least one media file includes the passenger selecting at least one media file through the web interface of which a copy of the media file is uploaded to a server.

11. The method of claim 8, wherein said receiving a copy of at least one media file from a passenger prior to a trip by the vehicle and storing a corresponding copy of the at least one media file in the content data source, includes copying a corresponding file to a portable media loader and copying a corresponding file from the portable media loader to the content data source.

12. The method of claim 8, wherein said receiving a copy of at least one media file from a passenger prior to a trip by the vehicle and storing a corresponding copy of the at least one media file in the content data source, includes the passenger identifying at least one of a departure and a return trip, the method further comprising deleting the corresponding copy of the at least one media file from the content data source after completion of at least one of the departure and return trip.

13. The method of claim 8, wherein said receiving at least one media file from a passenger prior to a trip by the vehicle and storing a corresponding copy of the at least one media file in the content data source, includes receiving a password and username from the passenger and associating the at least one media file with the username, and said verifying the authentication information received includes determining whether a username and password entered by a passenger when onboard correspond to one another.

14. The method of claim 8, wherein said permitting access to the corresponding copy of at least one media file via the information processing device includes presenting a media selection to the passenger which results in streaming of the corresponding copy to the information processing device for viewing thereon by the passenger.

15. A system for use with a passenger information processing device for providing entertainment on a vehicle for passengers, the system comprising:
a network and a content data source onboard the vehicle, the content data source connected in communication with the network and including stored media files;
seat displays disposed in the vehicle, each seat display connected in communication with the network and configured to present media selections to passengers corresponding to media files stored in the content data source and available over the network for streaming to the seat display in which each seat display is configured to receive an input from a passenger for streaming a selected media file to the seat display;
a web interface available via an Internet connection with an information processing device;
a ground server not carried with the vehicle, the ground server being connected in communication with the web interface, in which a passenger uses the web interface prior to an upcoming trip by the vehicle to select a personal media file from a passenger information processing device in which a copy of the selected personal media file is communicated to the ground server and to the content data source aboard the vehicle, wherein the personal media file is available over the network from the content data source upon entry of authentication information by the passenger.

16. The system of claim 15, wherein the authentication information comprises a password and username entered by the passenger that selected the personal media file for upload.

17. The system of claim 15, wherein each seat display includes program logic which performs task including:
accepting authentication information from a passenger;
verifying the authentication information received by comparison with information available from the network, and if the authentication information is successfully verified, presenting a media selection corresponding to the personal media file that was selected for upload.

18. The system of claim 15, further comprising an onboard server connected in communication with the network and carried with the vehicle, the onboard server including data storage in which the content data source comprises at least a portion of the data storage of the onboard server.

19. The system of claim 15, wherein web interface requires entry of information identifying at least one future trip scheduled by the vehicle, which after completion of the trip any copy of the personal media file is deleted from the content data source.

20. The system of claim 15, wherein available storage space of the content data source is monitored, and if insufficient space is available for storage of a personal media file, and if a personal media file from a completed trip is stored, said personal media file from a completed trip is deleted from the content data source.
